(19) United States
(12) Patent Application Publication
(10) Pub. No.: US 2007/0030781 A1
(43) Pub. Date: Feb. 8, 2007

(54) Tamper resistant security data on optical media

(75) Inventor: Mark L. Benedikt, Kirkland, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/182,569

(22) Filed: Jul. 15, 2005

(51) Int. Cl. G11B 19/04

(52) U.S. Cl. 369/53.21

(57) ABSTRACT

A system and method for writing and extracting tamper resistant security data onto optical media such as for example CDs and DVDs. A unique digital identifier may be embedded onto the lead-in area and/or lead-out area of an optical media, which areas are inaccessible in conventional optical media readers. The digital identifier includes data which, when read, may be used to validate the authenticity of the media, including for example a unique digitally signed serial number for the media, the time and date the media was fabricated and a location where the media was fabricated.

### BACKGROUND

Description of the Related Art

Each year, software piracy drains the U.S. economy of billions of dollars and thousands of skilled high-paying jobs. Technological developments which have made it easier for software manufacturers to provide inexpensive products have also made it easier for software pirates to cheaply replicate and profitably market large volumes of optical media such as CDs and DVDs. This software piracy is also fueling organized crime.

There are many different types of software piracy. End-user piracy is the copying of software without appropriate licensing for each copy. Pre-installed software piracy is when a computer manufacturer takes one copy of software and illegally installs it on more than one computer. Internet piracy is the downloading of unauthorized software over the Internet. And counterfeiting is the making and distribution of illegal copies of software in packaging that replicates a legitimate manufacturer's packaging. Counterfeit media range in quality from hand-labeled recordable CDs to high quality replicas of genuine installation CDs.

Since the early 1990s, Microsoft Corporation has been using anti-counterfeiting technology, including holographic images to help protect its intellectual property, its customers, and its channel partners. One such measure is a certificate of authenticity (“COA”), which is a label affixed to packaging for genuine software. The COA is embedded with security features that verify authenticity of a product. The COA may include various visual identifiers, such as product ID and product Key code numbers used to activate the product. The COA may also include physical properties, such as for example a metallic thread woven into the label to indicate that the associated software is genuine. Various holograms have also been added to the non-data side of pre-recorded and recordable optical media for additional security against counterfeiting. A variety of different holograms are used to make replication more difficult and to improve security.

While these security measures have proven effective to a degree in the past, software piracy is becoming more sophisticated. Additional security measures are required having more advanced features in an attempt to stay ahead of the counterfeiters.

Some conventional anti-piracy measures have also attempted to deal with the problem at the software level. The physical arrangement for data on a read-only compact disc (“CD-ROM”) is set forth in Philips' and Sony's ECMA-130, the so-called “Yellow Book” standard specification for CD-ROMs. Referring to the view of a conventional CD-ROM 20 in FIG. 1, the Yellow Book defines three separate data areas: a lead-in area 22, a program area 24 and a lead-out area 26.

Lead-in area 22 is provided to allow the laser pick-up head in the CD-ROM drive to calibrate itself to the tracks on the disc. Lead-in area 22 also includes one or more instances of a table of contents (“TOC”), having such information as the number of CD tracks, their starting locations, total length of data on the disc, and identification of type of disc. The instances of the TOC are placed in Q-subcode at the end of the lead-in area 22.

Program area 24 is where all of the data is recorded on the disc. The program area contains up to about 80 minutes of data divided into a maximum of 99 tracks. Lead-out 26 includes flags indicating the end of the CD program area, but is otherwise empty.

Other optical media, such as audio CDs and DVDs, have different data but a similar physical arrangement. Each includes a lead-in at the inner diameter without data, a lead-out at the outer diameter without data, and a data-carrying area between the lead-in and lead-out.

As the lead-in and lead-out do not contain data, conventional optical media drives do not read data in the lead-in or lead-out areas. In the lead-in, the laser pickup head does not start reading data until it reaches the TOC. Similarly, once the laser pick-up head detects the lead-out, this signifies an end to the data region and the drive stops reading.

### SUMMARY

Embodiments are directed to a system and method for writing and extracting tamper resistant security data onto optical media such as for example CDs and DVDs. A unique digital identifier may be embedded onto the lead-in area and/or lead-out area of an optical media, which areas are inaccessible in conventional optical media readers. The digital identifier includes data which, when read, may be used to validate the authenticity of the media, including for example a unique digitally signed serial number for the media, the time and date the media was fabricated and a location where the media was fabricated. Such a system enables both copy protection and inventory management features.

The digital identifier may be embedded in the lead-in and/or lead-out of the media during the same process that application program(s) and data are written to the program area of the media. The digital identifier may be written before or after an ISO image is recorded on the media, or the digital identifier may be part of the ISO image recorded on the media.

Conventional optical media readers do not read data in the lead-in or lead-out areas of an optical media. According to embodiments of the present inventive system, a validation engine may be included as part of the computing system environment, which validation engine communicates with a controller for an optical media reading device. The validation engine provides the controller with commands instructing the optical media reading device to scan for data in the lead-in and/or lead-out areas of an optical media. If no digital identifier is found, feedback is provided to indicate that the media is not authentic. If the digital identifier is found, the digital identifier data is compared with information stored in memory local to computer or elsewhere to confirm validation. If the digital identifier matches the stored information, feedback is provided indicating that the media is authentic.

The present system and method for validating media may be used by field agents, law enforcement and in legal proceedings as a quick, easy and effective method of validating media and identifying counterfeit media. End users would likely never know of the existence of the digital identifier. And in the event they did, they would not have an optical media reading device capable of accessing the digital identifier. Thus, the present system and method provide an effective means of combating counterfeit media that is not easily defeated or circumvented.

### BRIEF DESCRIPTION OF THE DRAWINGS

The present system will now be described with reference to the figures.

FIG. 1 is a top view of a conventional optical disc.

FIG. 2 is a top view of an optical disc according to embodiments of the present system.

FIG. 3 is a flowchart of a process for forming a digital identifier on an optical media according to embodiments of the present system.

FIG. 4 is a flowchart showing a process for completing the formation of a compact disc after embedding of the digital identifier.

FIG. 5 is a flowchart of a process for reading a digital identifier from an optical media according to embodiments of the present system.

FIG. 6 is a flowchart of a process for reading a digital identifier from an optical media according to an alternative embodiment of the present system.

FIG. 7 is a block diagram of computer hardware suitable for implementing embodiments of the present system.

FIG. 8 is a block diagram of a validation engine for performing the present system.

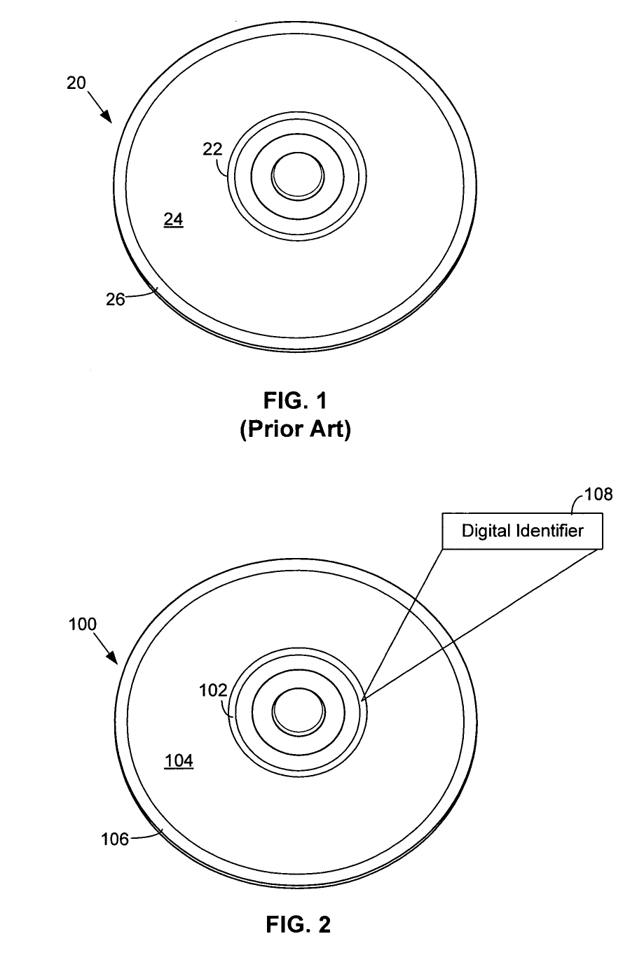

### DETAILED DESCRIPTION

Embodiments of the present system will now be described with reference to FIGS. 2 through 8 which relate to a system and method for writing and extracting security data on optical media such as CD-ROMs and DVDs. The system associates copy protection information and inventory tracking information with the actual media using manufacturing processes by embedding a unique digital identifier onto a portion of the media which is inaccessible in conventional optical media readers. Such a system enables both copy protection and inventory management features.

The present system is described hereinafter with respect to optical media such as, for example, CD-ROMs and DVDs. However, it is understood that the present system may be used on a variety of other optical media, including for example high definition DVDs (HD-DVDs), Blu-Ray discs, audio compact discs and video laser discs. Other optical media are contemplated.

Referring now to FIG. 2, there is shown media 100 including an embedded digital identifier 108 according to embodiments of the present system. As used herein, the term “media” may be used to refer to both a single media (e.g., a single optical disc) and a plurality of media (e.g., two optical discs). Media 100 may have a physical arrangement for data as set forth in Philips' and Sony's ECMA-130, the Yellow Book standard specification for certain optical media, which specification is incorporated herein by reference in its entirety. In accordance with the Yellow Book standard specification, media 100 may include a lead-in area 102 at an inner diameter of the media, a program area 104 radially outward from the lead-in area 102, and a lead-out area 106 radially outward from program area 104. It is understood that media 100 may vary from the Yellow Book standard specification in alternative embodiments of the present system.

Lead-in area 102 may be an annular region extending between 23 mm and 25 mm from the rotational axis of media 100 (i.e., an annular ring 2 mm wide). Program area 104 may be an annular region extending between 25 mm and 58 mm from the rotational axis of media 100. And lead-out area 106 may be an annular region extending between 58 mm and 58.5 mm from the rotational axis of media 100. It is understood that the various dimensions for lead-in area 102, program area 104, and lead-out area 106 may vary in alternative embodiments of the present system. As one example, where the application program(s) and data written in the program area 104 take up a small portion of the available program area 104, the lead-out area 106 may be positioned closer to the inner diameter of the media than 58 mm.

In embodiments of the present system, a digital identifier 108 may be embedded in lead-in area 102. The position of the digital identifier 108 may vary within lead-in area 102, but may be embedded within the lead-in area 102 before the first instance of the table of contents conventionally located within the lead-in area 102. For example, where lead-in area 102 has approximately 90 seconds of recording time, the digital identifier 108 may be recorded in the last 30 seconds of the lead-in area, before the first instance of the table of contents. However, the digital identifier may be located earlier in the lead-in area 102 in alternative embodiments.

The digital identifier 108 may include a wide variety of data, which may be organized into a wide variety of formats on the media 100. In general, the digital identifier includes data which, when read as explained hereinafter, may be used to validate the authenticity of media 100. The data may relate to the fabrication history of the media 100, unique identification information known only to the source of authentic media and/or information descriptive of the application program(s) recorded on the media. For example, the digital identifier 108 may include a unique digitally signed serial number for the media, the time and date the media was fabricated, a location where the media was fabricated, an operator ID of the outside manufacturer for a pre-production run (in the case of pre-recorded media) and a mapping of a unique digitally signed sequence number back to a point of sale transaction (in the case of a built-to-order recordable media). In embodiments, the digital identifier 108 may be used to validate every step of the fabrication process. It is understood that a wide variety of other data may be included as part of the digital identifier in addition to, or instead of, the above-described data.

The data included within the digital identifier may be organized into bytes, words or other data structures, and may be encrypted according to a variety of known encrypting algorithms. As explained hereinafter, the data in the digital identifier may also be encoded by known EFM (8-14 modulation) and CERC (Cross-Interleaved Read-Solomon code) error correction.

The information contained within the digital identifier 108 may be written during the same process for recording data in program area 104 as explained hereinafter. In embodiments of the present system, the digital identifier may be written once in the lead-in area 102, however it is contemplated that the digital identifier may be repeated a plurality of times in lead-in area 102.

In alternative embodiments of the present system, the digital identifier 108 as described above may be recorded in lead-out area 106. The digital identifier 108 may be embedded only in lead-out area 106, or the digital identifier may be repeated one or more times in the lead-in area 102 and/or lead-out area 106. In a further embodiment of the present system, a portion of a digital identifier 108 may be embedded in the lead-in area 102, and a portion of the digital identifier may be embedded in the lead-out area 106.

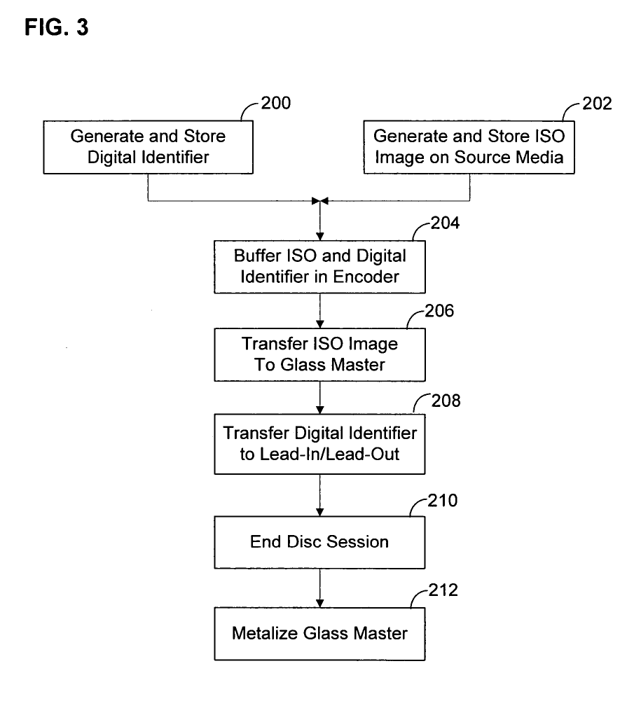

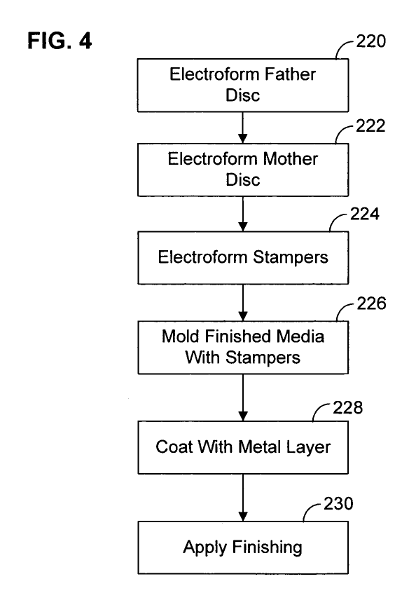

There are a variety of processes by which digital identifier 108 may be embedded on media 100. For example, the digital identifier 108 may be recorded during the known process of fabricating a glass master, from which father, mother and stamper discs are formed. This process is shown and described with respect to FIGS. 3 and 4. However, it is understood that the digital identifier may be included on media 100 by a variety of other recording processes. For example, in a further embodiment, the digital identifier 108 may be recorded on media 100 in a so-called built-to-order system, where the digital identifier may be included as part of the ISO imaging system software which is sent to a recording device for writing a unique or multiple recordable pieces of media.

The process for embedding a digital identifier 108 in lead-in area 102 and/or lead-out area 106 on a glass master will now be described in greater detail with reference to the flow chart of FIG. 3. The content for the digital identifier 108 is generated and stored on a secure server or the like in a step 200. Independent of the generation and storage of the digital identifier, an ISO image of the program application(s) and data to be recorded in program area 104 is created and stored on a source media (typically CD or tape) in step 202. In general, an ISO image is a disc image (as prescribed by ISO standard ISO 9660) that comprises a file representing a one-to-one copy of a specific computer file system, most widely used for the compact disc media (i.e., an entire CD-ROM or DVD). The term “ISO image” is sometimes used informally to refer to disc images in formats other than ISO 9660, and is used herein to refer to any seed image of a disc suitable for reproduction. Step 202 may occur before, during or after step 200.

In step 204, the ISO image from the source media and digital identifier from the storage area are buffered into an encoder which encodes both the ISO image and digital identifier. As explained hereinafter, information is recorded onto a glass master as a result of a laser creating “pits” and “lands” along a spiral track on a surface of the glass master. The encoder is a pulse control system that allows manufacturing facilities to control pit geometry on the glass master at the laser beam recorder to create optical media. Manufacturing facilities can make duty cycle adjustments on leading and trailing edge timing, thereby adjusting individual pit lengths on the glass master.

The digital identifier and application program(s)/data may be recorded on media 100 using known modulation and/or error correction techniques. For example, EFM (8-14 modulation) may be used where each 8-bit symbol is encoded as 14 bits plus 3 merging bits. Additionally, or alternatively, CERC (Cross-Interleaved Read-Solomon code) error correction may be used which adds two-dimensional parity information to correct errors and to interleave the data on the disc to protect the data from burst errors.

In step 206, the ISO image is transferred to a glass master by a laser beam recorder (“LBR”) in a known process. The glass master includes a layer of light-sensitive photoresist. The photoresist is exposed to a modulated beam of a short-wavelength light from the LBR. This modulated beam encodes the ISO image data by the formation of the pits and lands along a spiral track in the photoresist layer. In particular, the data is defined by the length of and spacing between the pits. As a result of the mastering process of step 206, the table of contents is recorded in the lead-in area on the glass master, and the encoded application program(s) and data are recorded in the program area on the glass master.

After the ISO image is transferred to the glass master in step 206, the digital identifier may be written by the LBR to the lead-in area (before the first instance of the table of contents) and/or to the lead-out area (after the end of the program area) in step 208. The process for recording the digital identifier may generally be the same as the process for recording the ISO image—the LBR modulated beam encodes the digital identifier by the formation of the pits and lands along a spiral track in the photoresist layer. An LBR controller is configured to add the digital identifier in the lead-in area at a desired location before the known location of the first instance of the table of contents. Alternatively or additionally, the LBR controller adds the digital identifier at the desired location in the lead-out area after the known location of the end of the program area. In the above-described embodiment, the ISO image may be recorded on the glass master and the digital identifier added thereafter. However, in alternative embodiments, the digital identifier may be added in either the lead-in or lead-out before the ISO image is transferred onto the glass master.

The disc recording session closes out in step 210. The glass master may be metalized in a step 212 by, for example, electroplating a layer of Nickel on the exposed photoresist layer.

FIG. 4 shows a known electroforming and molding process for manufacturing end user media from a glass master. In electroforming, the finished glass master is first used to create a “father” disc in step 220 which, instead of pits, has bumps on the surface of the disc. When the father is completed, the side containing the bumps is oxidized to allow for the electroforming of a “mother” disc from the father in step 222. The resulting mother is then subsequently used to make “stampers” in step 224. The stampers are discs used in a molding process in step 226 to stamp the pits and lands into a molten substrate such as polycarbonate, which hardens into the finished optical media. The step of creating the mother and stampers may be omitted and the father used in the mold to create the finished optical media.

The surface of an optical media may then be coated with a thin reflective metal layer (such as aluminum) in a step 228. Media finishing in step 230 comprises applying lacquer or other labeling to the disc. Various changes may be made to the above processes described with respect to FIGS. 3 and 4 as is known in the art.

In the embodiment described above, the digital identifier is not part of the ISO image. In an alternative embodiment, the digital identifier may be pre-imaged by a pre-mastering system so that the digital identifier is part of the ISO image encoded onto the digital media. Moreover, as indicated above, in further embodiments, the digital identifier may be embedded on built-to-order media where the digital identifier may be included into the media ISO imaging system software. In such embodiments, the image may then be sent to a recording device for writing to a unique or multiple recordable pieces of media.

As indicated above, the digital identifier is written to the lead-in area and/or the lead-out area, which are areas where data is not accessed by conventional optical media reading devices. Thus, an end user of media 100 would never see this area or the digital identifier, and would not be able to access data in this area without a specialized optical media reading device according to the present system as explained below. In particular, in conventional optical media reading devices, the laser pick-up head does not scan for data in the lead-in or lead-out areas. In the lead-in area, the laser pick-up head is calibrating, trying to find tracks on the media. The laser pick-up head is not sending data back to the controller or the operating system while calibrating and scanning in the lead-in area. Data is sent back to the controller and/or operating system only upon the laser pick-up head encountering the table of contents. Similarly, feedback of data ends when the laser pick-up head leaves the program area and enters the lead-out area.

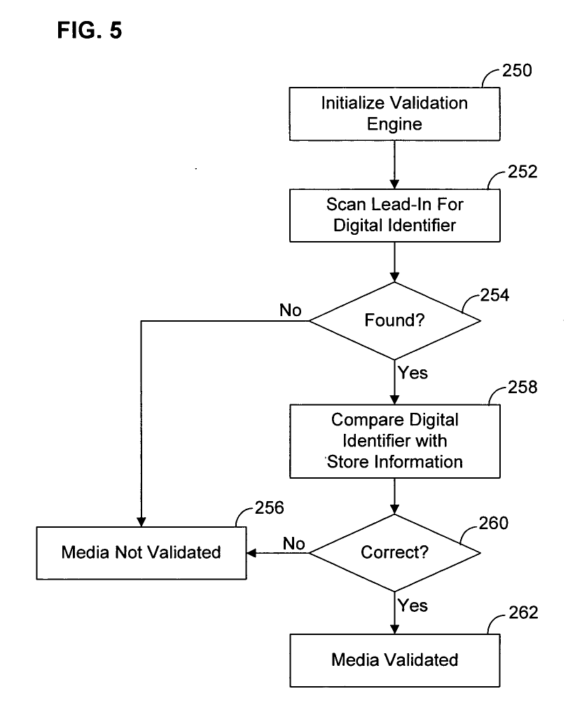

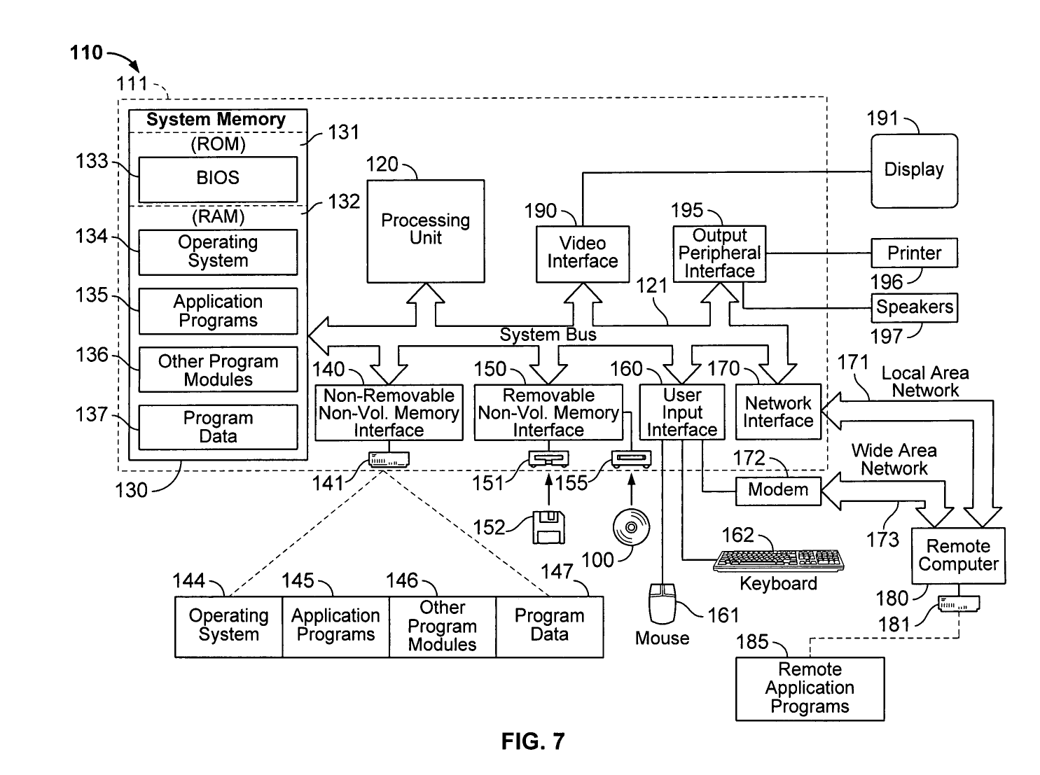

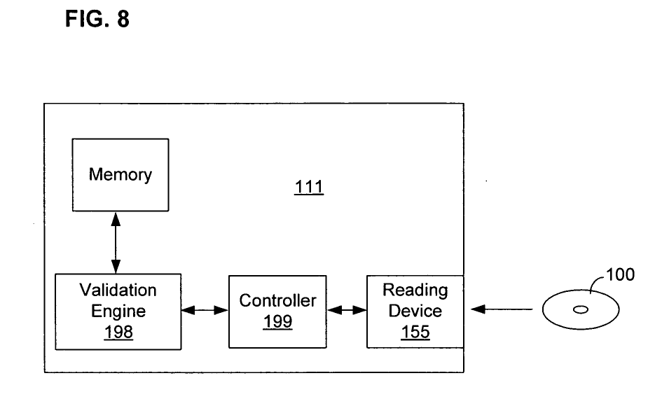

A process for reading a digital identifier according to embodiments of the present system will now be described with reference to FIG. 5. The process described in FIG. 5 may be implemented by an optical media reading device 155 forming part of a computing system environment 110 described in greater detail hereinafter with respect to FIGS. 7 and 8. As indicated above, conventional optical media readers do not read data in the lead-in or lead-out areas of an optical media. According to the present inventive system, and as shown in FIGS. 7 and 8, computing system environment 110 may include a validation engine 198 communicating with a controller 199 for optical media reading device 155. The validation engine 198 provides controller 199 with commands, such as for example SCSI commands, instructing the optical media reading device 155 to look for data in the lead-in and/or lead-out of an optical media. Once the digital identifier is found, the digital identifier data is compared with information stored in memory local to computer 111 or elsewhere to confirm validation.

Referring now to FIG. 5, in order to validate a media 100, a user initiates the validation engine 198 in step 250, for example by launching a program application for the validation engine 198 on the computer 111. In embodiments where the digital identifier is located in the lead-in area, upon receipt of a media 100 to be validated, validation engine 198 causes the optical media reading device 155 to scan for data in the lead-in area in step 252. The laser pick-up head in reading device 155 will calibrate within the lead-in area, and then scan for the digital identifier.

If the laser pick-up head does not find the digital identifier before it reaches the first instance of the table of contents (step 254), then visual and/or audible feedback is given in step 256 that the media was not validated. If the digital identifier is found in step 254, the digital identifier is then compared against information relating to the digital identifier stored in memory (either locally within computer 111 or remotely) in step 258. If the comparison indicates in step 260 that the digital identifier is correct, feedback is given that the media is validated in step 262. If the comparison indicates in step 260 that the digital identifier is not correct, the feedback of step 256 is given that the media is not validated.

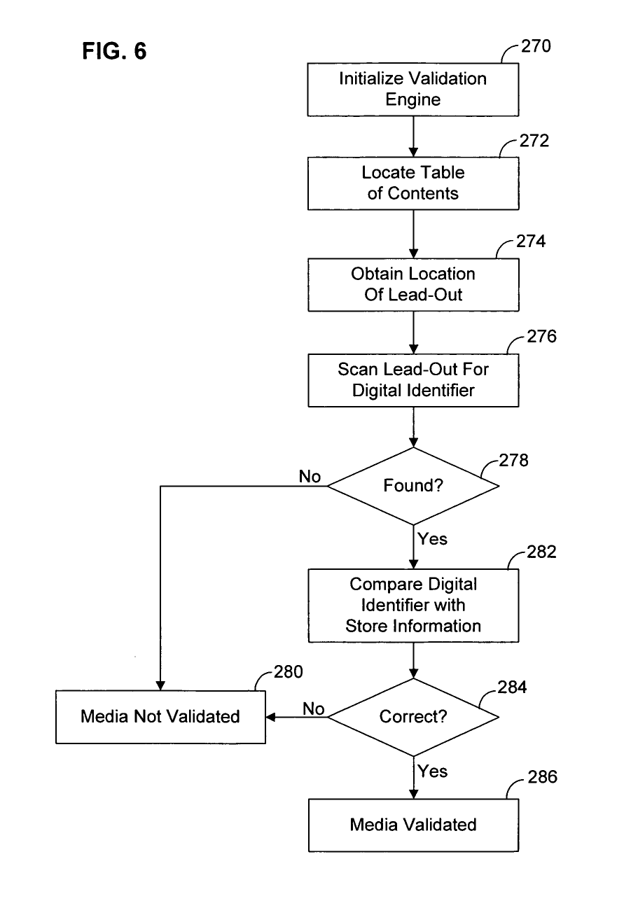

An alternative embodiment for the operation of an optical media scanning device is shown in FIG. 6. In this embodiment, the digital identifier is recorded in the lead-out area. In this embodiment, in order to validate a media 100, a user initiates the validation engine 198 in step 270, for example by launching a program application for the validation engine on the computer 111. Upon receipt of a media 100 to be validated, validation engine 198 causes the optical media reading device 155 to locate the table of contents in step 272. The location where the program area ends and the lead-out area begins is obtained from the table of contents in step 274. The validation engine 198 then causes the optical media reading device 155 to scan for data in the lead-out area in step 276.

If the laser pick-up head does not find the digital identifier in the lead-out area (step 276), then visual and/or audible feedback is given in step 278 that the media was not validated. If the digital identifier is found in step 276, the digital identifier is compared against information relating to the digital identifier stored in memory (either locally within computer 111 or remotely) in step 280. If the comparison indicates in step 282 that the digital identifier is correct, feedback is given that the media is validated in step 284. If the comparison indicates in step 282 that the digital identifier is not correct, the feedback of step 278 is given that the media is not validated.

The above-described system and method for validating media may be used by field agents, law enforcement and in legal proceedings as a quick, easy and effective method of validating media and identifying counterfeit media. End users would likely never know of the existence of the digital identifier. And in the event they did, they would not have an optical media reading device capable of accessing the digital identifier. Thus, the present system and method provide an effective means of combating counterfeit media that is not easily defeated or circumvented.

FIG. 7 illustrates an example of a suitable general computing system environment 110 that may comprise any processing device shown herein on which the inventive system may be implemented. The computing system environment 110 is only one example of a suitable computing environment and is not intended to suggest any limitation as to the scope of use or functionality of the inventive system. Neither should the computing system environment 110 be interpreted as having any dependency or requirement relating to any one or combination of components illustrated in the exemplary computing system environment 110.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 7, an exemplary system for implementing the inventive system includes a general purpose computing device in the form of a computer 111. Components of computer 111 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 111 may include a variety of computer readable media. Computer readable media can be any available media that can be accessed by computer 111 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile discs (DVD) or other optical disc storage, magnetic cassettes, magnetic tape, magnetic disc storage or other magnetic storage devices, or any other medium which can be used to store the desired information and which can be accessed by computer 111. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 111, such as during start-up, is typically stored in ROM 131. RAM 132 typically contains data and/or program modules that are immediately accessible to and/or presently being operated on by processing unit 120. By way of example, and not limitation, FIG. 7 illustrates operating system 134, application programs 135, other program modules 136, and program data 137.

The computer 111 may also include other removable/non-removable, volatile/nonvolatile computer storage media. By way of example only, FIG. 7 illustrates a hard disc drive 141 that reads from or writes to non-removable, nonvolatile magnetic media and a magnetic disc drive 151 that reads from or writes to a removable, nonvolatile magnetic disc 152.

As discussed above, computer 111 may further include an optical media reading device 155 customized according to the inventive system to read a digital identifier within the lead-in and/or lead-out of optical media 100.

Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disc drive 141 is typically connected to the system bus 121 through a non-removable memory interface such as interface 140, magnetic disc drive 151 and optical media reading device 155 are typically connected to the system bus 121 by a removable memory interface, such as interface 150.

The drives and their associated computer storage media discussed above and illustrated in FIG. 7, provide storage of computer readable instructions, data structures, program modules and other data for the computer 111. In FIG. 7, for example, hard disc drive 141 is illustrated as storing operating system 144, application programs 145, other program modules 146, and program data 147. These components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 111 through input devices such as a keyboard 162 and a pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 111 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 111, although only a memory storage device 181 has been illustrated in FIG. 7. The logical connections depicted in FIG. 7 include a local area network (LAN) 171 and a wide area network (WAN) 173, but may also include other networks. Such networking environments are commonplace in offices, enterprise-wide computer networks, intranets and the Internet.

When used in a LAN networking environment, the computer 111 is connected to the LAN 171 through a network interface or adapter 170. When used in a WAN networking environment, the computer 111 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 111, or portions thereof, may be stored in the remote memory storage device. By way of example, and not limitation, FIG. 7 illustrates remote application programs 185 as residing on memory device 181. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

I claim:

1. An optical media including a lead-in area, a program area and a lead-out area, the optical media comprising:
data within at least one of the lead-in area and the lead-out area for validating a source of the media.

2. An optical media as recited in claim 1, the data comprising one or more of a serial number, a time the media was fabricated, a date the media was fabricated, a location where the media was fabricated, an identification of an operator involved with the fabrication of the media, and a descriptor of software recorded on the media.

3. An optical media as recited in claim 1, the data recorded in the lead-in area, before a table of contents on the media.

4. An optical media as recited in claim 1, the data recorded in the lead-out area, before a table of contents on the media.

5. An optical media as recited in claim 1, the optical media comprising one of a compact disk read only memory, a DVD, a high definition DVD, an audio compact disk, a Blu-Ray disc and a video laser disc.

6. An optical media as recited in claim 1, the optical media conforming to the Yellow Book ECMA-130 standard specification for optical media.

7. An optical media as recited in claim 1, the optical media not conforming to the Yellow Book ECMA-130 standard specification for optical media.

8. A system for validating the authenticity of an optical media, the system comprising:
an optical media having a lead-in area, a program area and a lead-out area, the optical media including data within at least one of the lead-in area and the lead-out area for validating a source of the media;
an optical media reading device for reading data from the optical media; and
a controller for the optical media reading device, the controller directing the optical media reading device to scan for data in at least one of the lead-in area and the lead-out area.

9. A system for validating the authenticity of an optical media as recited in claim 8, the data comprising one or more of a serial number, a time the media was fabricated, a date the media was fabricated, a location where the media was fabricated, an identification of an operator involved with the fabrication of the media, and a descriptor of software recorded on the media.

10. A system for validating the authenticity of an optical media as recited in claim 8, the data recorded in the lead-in area, before a table of contents on the media.

11. A system for validating the authenticity of an optical media as recited in claim 8, further comprising a validation engine for providing commands to the controller for the optical media reading device.

12. A system for validating the authenticity of an optical media as recited in claim 8, further comprising information stored in memory associated with the system, the information capable of verifying the data stored within at least one of the lead-in area and the lead-out area.

13. A method of validating the authenticity of an optical media, the optical media including a lead-in area, a program area and a lead-out area, the method comprising the steps of:
(a) writing data to at least one of the lead-in area and lead-out area; and
(b) scanning for data in at least one of the lead-in and lead-out areas, said step (b) of scanning for data including the step of reading the data written in said step (a).

14. A method as recited in claim 13, said step (a) of writing data to at least one of the lead-in area and lead-out area comprising the step of buffering the data, along with an ISO image, in an encoder for a laser beam recorder.

15. A method as recited in claim 14, said step (a) of writing data to at least one of the lead-in area and lead-out area comprising the step of writing data to the lead-in area before the ISO image is written to a program area on the optical media.

16. A method as recited in claim 13, said step (a) of writing data to at least one of the lead-in area and lead-out area comprising the step of writing data to the lead-in area as part of an ISO image written to the optical media.

17. A method as recited in claim 13, said step (b) of scanning for data in at least one of the lead-in and lead-out areas, comprising the step of configuring an optical media reading device with one or more commands to search within at least one of the lead-in and lead-out areas.

18. A method as recited in claim 13, further comprising the step of providing at least one of visual and audible feedbacks if no data is found relating to the validity of the optical media in at least one of the lead-in and lead-out areas, the feedback indicating the optical media is not authentic.

19. A method as recited in claim 13, further comprising the step of comparing data read in at least one of the lead-in and lead-out areas against information stored in memory relating to validating authentic optical media.

20. A method as recited in claim 19, further comprising the step of providing at least one of visual and audible feedbacks relating to the validity of the optical media based on the comparison of the data read in at least one of the lead-in and lead-out areas and the information stored in memory relating to validating authentic optical media.
